(19) United States
(12) Patent Application Publication
(10) Pub. No.: US 2026/0200348 A1
(43) Pub. Date: Jul. 16, 2026

(54) CHARGING INLET

(71) Applicant: YAZAKI CORPORATION, Tokyo (JP)

(72) Inventor: Tsukasa Matsudaira, Kakegawa-shi (JP)

(21) Appl. No.: 19/420,700

(22) Filed: Dec. 15, 2025

(30) Foreign Application Priority Data
Jan. 14, 2025 (JP) 2025-004507

(51) Int. Cl. B60L 53/16; B60L 53/30

(52) U.S. Cl. CPC B60L 53/16; B60L 53/30

(57) ABSTRACT

A charging inlet includes: a charging inlet main body configured to be installed in a vehicle and including a tubular hood, wherein the hood is configured for fitting a connected end of a charging connector therein to connect the connected end to the charging inlet main body so that power is supplied to the charging inlet main body from the charging connector; a lock mechanism including a pin element, wherein when the charging connector is connected to the charging inlet main body, the lock mechanism is configured to introduce a tip end of the pin element into the inside of the hood to cause the tip end to enter a lock recess in an outer surface of the connected end of the charging connector so that removal of the charging connector is limited during a charging process; and a pin heating section configured to heat the pin element.

### BACKGROUND OF THE INVENTION

### Technical Field

The present invention relates to a charging inlet configured to receive power from a charging connector.

### Background Art

Conventionally, a charging inlet is widely used which is installed in a vehicle, such as an electric vehicle, wherein power is supplied to the charging inlet from a charging connector that is provided at a charging cable end (see e.g. Patent Document 1). The charging inlet according to Patent Document 1 has a structure in which various terminals are arranged inside a tubular hood. The hood is configured for fitting a connected end of the charging connector therein to connect the connected end to the hood so that power is supplied to the charging inlet. In this case, a lock mechanism as a mechanism for limiting removal of the charging connector during a charging process may be provided in the charging inlet, wherein the lock mechanism is configured to limit the removal by inserting a tip end of a pin element into the hood during connection and thus into a recess in the charging connector.

### Citation List

### Patent Literature

Patent Document 1: JP 2016-088250 A

### SUMMARY OF THE INVENTION

A vehicle including a charging inlet with a lock mechanism may be used in a cold climate region. However, in a cold climate region, freezing may occur around a pin in the lock mechanism so that the pin element may not be moved. Such a functional failure of the lock mechanism due to freezing in the cold climate region may in turn make the charging operation with the charging inlet difficult, and is therefore undesirable.

Therefore, the present invention is focused on the above-described problem, and an objective of the present invention is to provide a charging inlet which may achieve good charging even in a cold climate region while using a lock mechanism.

In order to achieve the above-mentioned objective, a charging inlet includes: a charging inlet main body configured to be installed in a vehicle and including a tubular hood, wherein the hood is configured for fitting a connected end of a charging connector therein to connect the connected end to the charging inlet main body so that power is supplied to the charging inlet main body from the charging connector; a lock mechanism including a pin element, wherein the pin element is configured to extend through a tubular wall of the hood to enter an inside of the hood, wherein when the charging connector is connected to the charging inlet main body, the lock mechanism is configured to introduce a tip end of the pin element into the inside of the hood to cause the tip end to enter a lock recess in an outer surface of the connected end so that removal of the charging connector is limited during a charging process; and a pin heating section configured to heat the pin element.

The above-described charging inlet may achieve good charging even in a cold climate region while using a lock mechanism.

### BRIEF DESCRIPTION OF THE DRAWINGS

FIG. 1 shows a front view of a charging inlet according to an embodiment from a connected side of a charging connector;

FIG. 2 shows a sectional view of the charging inlet as shown in FIG. 1 along the line V11-V11 in FIG. 1;

FIG. 3 shows a perspective view of the charging connector to be connected to the charging inlet as shown in FIGS. 1 and 2;

FIG. 4 shows a top view of the charging connector as shown in FIG. 3 connected to the charging inlet as shown in FIGS. 1 and 2 as viewed in a direction V12 of arrow in FIG. 1;

FIG. 5 shows a sectional view of the charging inlet and the charging connector in a connected state as shown in FIG. 4 along the line V13-V13 in FIG. 4;

FIGS. 6A and 6B show perspective views illustrating an appearance of a lock mechanism as shown in FIGS. 1, 2, 4 and 5; and

FIGS. 7A and 7B show enlarged sectional views illustrating how removal of the charging connector during a charging process is limited by the lock mechanism as shown in FIGS. 6A and 6B, which is shown in an enlarged view of an area A11 in FIG. 5.

### DETAILED DESCRIPTION OF THE PREFERRED EMBODIMENTS

Hereinafter, an embodiment of the charging inlet will be described.

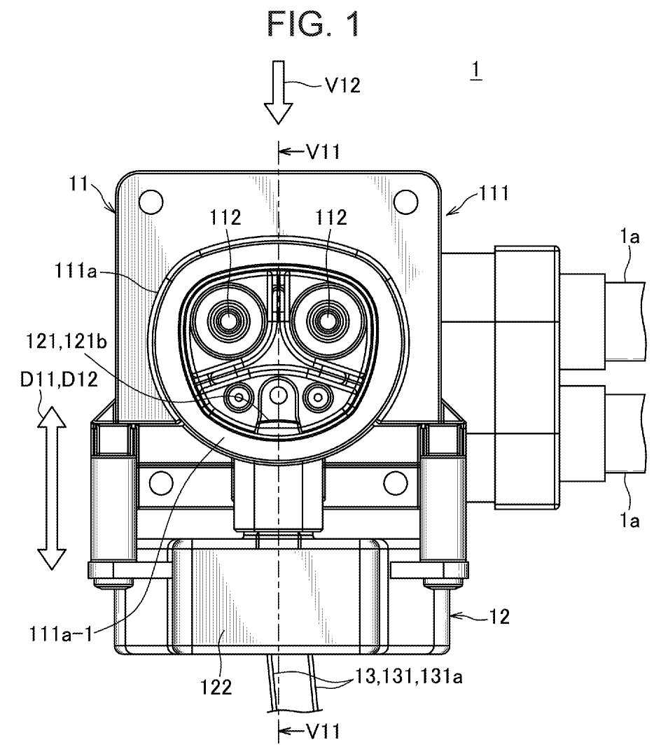

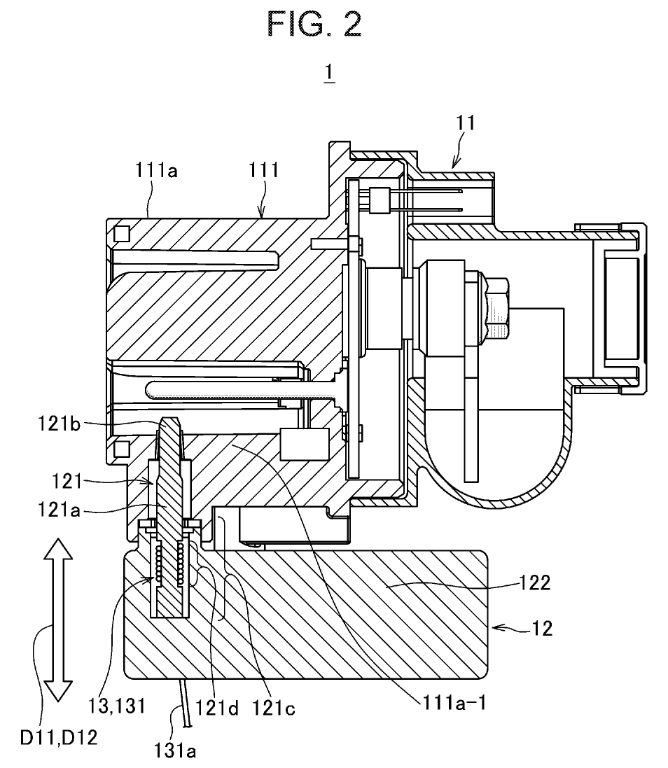

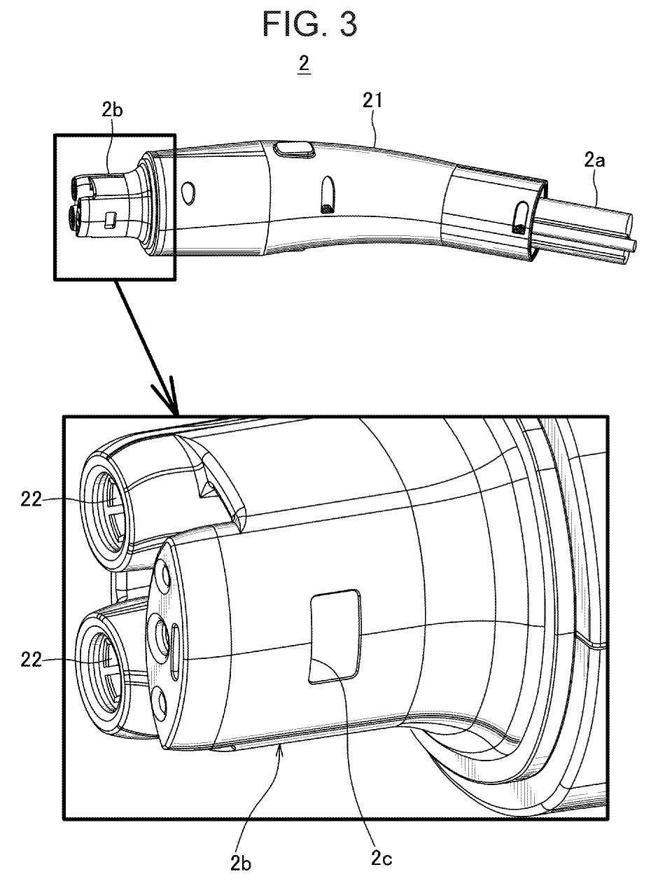

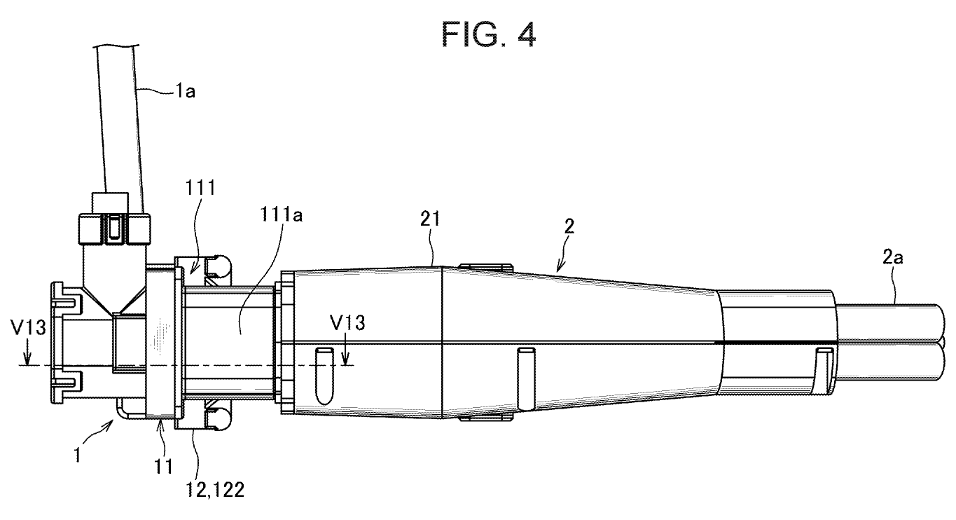

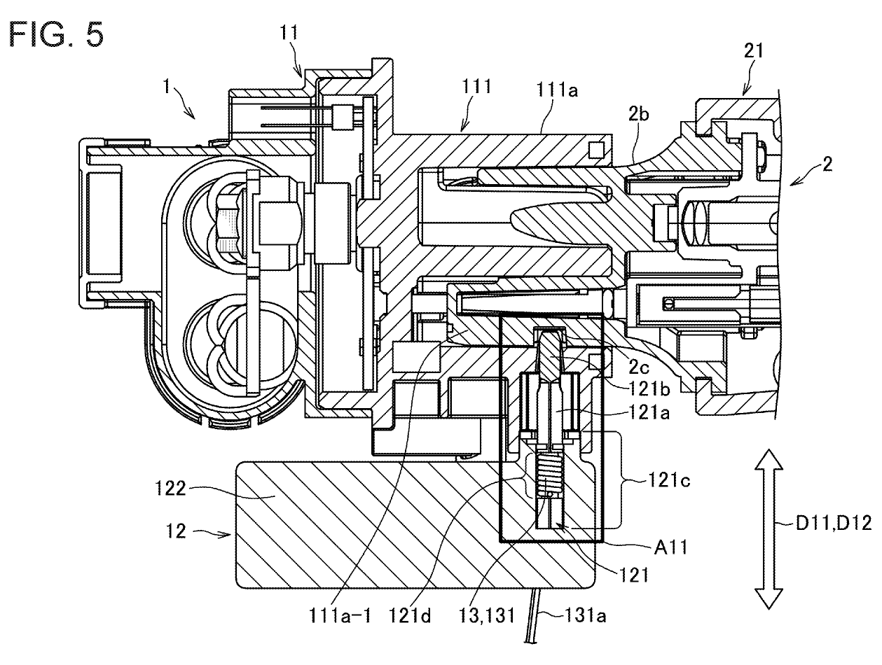

FIG. 1 shows a front view of a charging inlet according to an embodiment from a connected side of a charging connector. FIG. 2 shows a sectional view of the charging inlet as shown in FIG. 1 along the line V11-V11 in FIG. 1. FIG. 3 shows a perspective view of the charging connector to be connected to the charging inlet as shown in FIGS. 1 and 2. FIG. 4 shows a top view of the charging connector as shown in FIG. 3 connected to the charging inlet as shown in FIGS. 1 and 2 as viewed in a direction V12 of arrow in FIG. 1. FIG. 5 shows a sectional view of the charging inlet and the charging connector in a connected state as shown in FIG. 4 along the line V13-V13 in FIG. 4. It is to be noted that the view of FIG. 5 is shown with reversed right and left sides as compared with FIG. 2.

The charging inlet 1 according to the present embodiment is a component configured to be installed in a vehicle, such as an electric vehicle, wherein power is supplied to the charging inlet 1 from a charging connector 2 that is provided at an end of a charging cable 2a. The charging inlet 1 includes a charging inlet main body 11, a lock mechanism 12, and a pin heating section 13.

The charging inlet main body 11 is a component including an inlet housing 111 with a tubular hood 111a, wherein the inlet housing 111 is made of a resin. Various power receiving terminals 112 having a pin shape are arranged inside the hood 111a. A power supply cable 1a extends from a side of the charging inlet main body 11 opposite to a connected side thereof, wherein the connected side is provided for connection to the charging connector 2. The power supply cable 1a extends toward an onboard power supply to be charged, wherein the onboard power supply is located in the vehicle. The charging connector 2 for providing power supply to the charging inlet main body 11 is a component including a tubular connector housing 21, wherein the connector housing 21 is attached to an end of the charging cable 2a. Power supplying terminals 22 are accommodated inside the connector housing 21 and configured to be connected to the power receiving terminals 112 of the charging inlet main body 11. A connected end 2b of the charging connector 2 is fitted into the tubular hood 111a in the charging inlet main body 11 and connected to the hood 111a, wherein power is supplied to the hood 111a from the charging connector 2.

Next, the lock mechanism 12 included in the charging inlet 1 is a mechanism configured to limit removal of the charging connector 2 during a charging process in which the charging connector 2 is connected to the charging inlet 1, as shown in FIGS. 4 and 5.

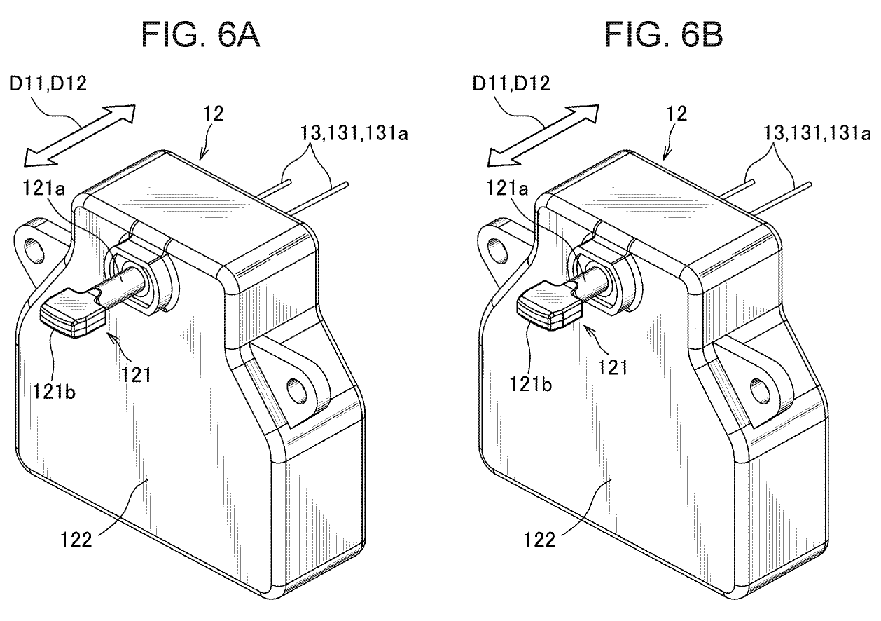

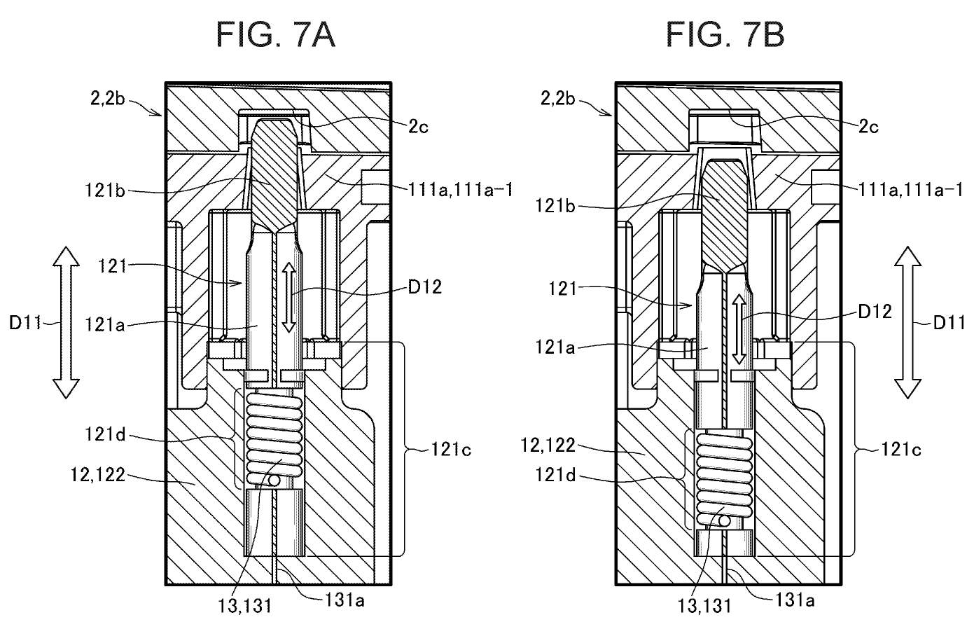

FIGS. 6A and 6B show perspective views illustrating an appearance of the lock mechanism as shown in FIGS. 1, 2, 4 and 5. FIGS. 7A and 7B show enlarged sectional views illustrating how removal of the charging connector during the charging process is limited by the lock mechanism as shown in FIGS. 6A and 6B, which is shown in an enlarged view of an area A11 in FIG. 5. FIGS. 6A and 7A show a state during the limitation while FIGS. 6B and 7B show a state before the limitation.

This lock mechanism 12 includes a pin element 121 and a driving section 122. The pin element 121 is configured to extend through a tubular wall 111a-1 of the hood 111a of the inlet housing 111 to enter the inside of the hood 111a. The pin element 121 includes a round rod portion 121a, at a tip of which a tip end 121b having a rectangular-plate shape is formed. A lock recess 2c is formed in an outer surface of the connected end 2b of the charging connector 2, wherein the lock recess 2c is recessed in a rectangular shape. When the charging connector 2 is connected to the charging inlet main body 11, the lock mechanism 12 causes the tip end 121b of the pin element 121 to enter the inside of the hood 111a. The lock mechanism 12 then causes the tip end 121b to enter the lock recess 2c in the outer surface of the connected end 2b so that removal of the charging connector is limited during the charging process. The driving section 122 in this lock mechanism 12 holds the pin element 121 so as to be movable forward and backward in a forward-backward direction D11, the forward-backward direction D11 intersecting the tubular wall 111a-1 of the hood 111a. When the charging connector 2 is connected to the charging inlet main body 11, the driving section 122 is configured to drive the pin element 121 to cause the tip end 121b of the pin element 121 to enter the inside of the hood 111a and to be thus inserted into the lock recess 2c. When the charging process is completed, the pin element 121 is moved back to remove the tip end 121b from the lock recess 2c, thereby releasing the limitation.

The pin heating section 13 included in the charging inlet 1 has a role of facilitating movement of the pin element 121 in the lock mechanism 12 in a cold climate region. In a cold climate region, freezing may occur around the pin in the lock mechanism 12 so that the pin element 121 may not be moved. In such a case, the pin heating section 13 heats the pin element 121 to eliminate the freezing, which allows the operation of the pin element 121. In addition, the pin element 121 includes a held portion 121c facing away from the tip end 121b, wherein the held portion 121c is provided to be held by the driving section 122, and wherein the pin heating section 13 is configured to heat the held portion 121c. This held portion 121c is part of the round rod portion 121a of the pin element 121 and accommodated inside the driving section 122.

The pin heating section 13 includes a heating electric wire 131 wound around the pin element 121, wherein the pin heating section 13 is configured to cause the heating electric wire 131 to generate heat via supplying a heating power to the heating electric wire 131 so that the pin element 121 is heated. According to the present embodiment, one or more enameled wires are used as the heating electric wire 131. The pin element 121 includes a diameter-reduced portion 121d in the held portion 121c of the pin element 121 facing away from the tip end 121b, wherein the diameter-reduced portion 121d has a reduced thickness for a predetermined length along a shaft length direction D12 of the pin element 121 as compared with the remainder of the pin element 121. Furthermore, the heating electric wire 131 of the pin heating section 13 is wound around the diameter-reduced portion 121d of the held portion 121c. The heating electric wire 131 includes an electric wire end 131a facing away from the pin element 121, wherein the electric wire end 131a is drawn out of the pin heating section 13 as well as out of the driving section 122 of the lock mechanism 12 and connected to an onboard power supply of the vehicle so that the heating power is supplied to the heating electric wire 131 from the onboard power supply.

The charging inlet 1 according to the embodiment described above enables the pin element 121 to be heated by the pin heating section 13 to eliminate freezing, even if the freezing occurs around the pin element 121 of the lock mechanism 12 in a cold climate region. In other words, the above-described charging inlet 1 may achieve good charging even in a cold climate region while using a lock mechanism 12.

According to the present embodiment, the pin element 121 includes the held portion 121c facing away from the tip end 121b, wherein the held portion 121c is provided to be held by the driving section 122, and wherein the pin heating section 13 is configured to heat the held portion 121c. In the pin element 121, the held portion 121c generally tends to exhibit more complex adhesion to a surrounding structure and a wider adhered range on the surrounding structure due to freezing as compared to the tip end 121b. The above-mentioned configuration thus enables such a held portion 121c to be heated so that the freezing may be effectively eliminated.

Furthermore, the present embodiment is configured such that the pin heating section 13 is configured to cause the heating electric wire 131 wound around the pin element 121 to generate heat the pin element 121. This configuration enables the pin element 121 to be effectively heated by using a simple structure, namely the heating electric wire 131 wound around the pin element 121.

Furthermore, the heating electric wire 131 of the pin heating section 13 according to the present embodiment is wound around the diameter-reduced portion 121d in the pin element 121. With this configuration, the diameter-reduced portion 121d with the heating electric wire 131 wound therearound has a smaller cross-section than the remainder of the pin element 121 which may retard release of heat from the diameter-reduced portion 121d, which allows the pin element 121 to be effectively heated. In addition, the diameter-reduced portion 121d is recessed as compared to an outer peripheral surface of the remaining pin region, around which the heating electric wire 131 is wound and accommodated in the recessed region, which makes it difficult to unwind the heating electric wire 131. Therefore, a good state of winding around the pin element 121 may be maintained even when the pin element 121 is moved during connection of the charging connector 2.

According to the present embodiment, the electric wire end 131a of the heating electric wire 131 is drawn out to be connected to the onboard power supply of the vehicle so that the heating power is supplied to the electric wire end 131a from the onboard power supply. This configuration may reduce the costs for heating by using the onboard power supply of the vehicle as compared to an additional power supply for eliminating freezing while heating the pin element 121 and thus eliminating the freezing.

It should be noted that the embodiment as described above merely shows a representative form of the charging inlet. The charging inlet is not limited thereto, but may be modified in various manners for implementation.

For example, the embodiment described above shows the charging inlet 1 as an example of the charging inlet, wherein the charging inlet 1 includes e.g. a specific appearance and specific shapes of various parts as shown in FIGS. 1 to 7. However, the charging inlet is not limited thereto, but e.g. any specific appearance and/or any specific shape of various parts may be used.

Furthermore, the embodiment described above shows the pin heating section 13 as an example of the pin heating section which is configured to heat the held portion 121c of the pin element 121 facing away from the tip end 121b, wherein the held portion 121c is provided to be held by the driving section 122. However, the pin heating section is not limited thereto, but another portion of the pin element may be heated which is different from the held portion held by the driving section. However, heating the held portion held by the driving section enables the freezing around the pin in the lock mechanism 12 to be effectively eliminated, as described above.

Moreover, the embodiment described above shows the pin heating section 13 as an example of the pin heating section which includes the heating electric wire 131 for heating the pin element 121. However, the pin heating section is not limited thereto, but any heat generating configuration may be used for the pin heating section. However, using the heating electric wire 131 enables the pin element 121 to be effectively heated with a simple structure, as described above. The present embodiment further shows the heating electric wire 131 as an example of the heating electric wire which uses an enameled wire. However, the heating electric wire is not limited thereto, and any electric wire can be used which can generate heat.

Moreover, the embodiment described above shows the charging inlet 1 as an example of the charging inlet in which the diameter-reduced portion 121d is provided in the pin element 121 of the lock mechanism 12, wherein the heating electric wire 131 of the pin heating section 13 is wound around the diameter-reduced portion 121d. However, the charging inlet is not limited thereto, but a heating electric wire may be also used which is wound around a pin element having a simple-rod shape without any diameter-reduced portion. However, the heating electric wire 131 wound around the diameter-reduced portion 121d of the pin element 121 enables the pin element 121 to be efficiently heated. Furthermore, such configuration may maintain a wound state of the heating electric wire 131.

In addition, the embodiment described above shows the pin heating section 13 as an example of the pin heating section in which the electric wire end 131a of the heating electric wire 131 is drawn out and connected to the onboard power supply of the vehicle. However, the pin heating section is not limited thereto, but the heating electric wire may extend in any specific manner. However, connection of the electric wire end 131a of the heating electric wire 131 to the onboard power supply of the vehicle may reduce the costs for heating while heating the pin element 121 and thus eliminating the freezing, as described above.

### Reference Signs List

1 Charging inlet

1a Power supply cable

2 Charging connector

2a Charging cable

2b Connected end

2c Lock recess

11 Charging inlet main body

12 Lock mechanism

13 Pin heating section

21 Connector housing

22 Power supplying terminals

111 Inlet housing

111a Hood

111a-1 Tubular wall

112 Power receiving terminals

121 Pin element

121a Round rod portion

121b Tip end

121c Held portion

121d Diameter-reduced portion

122 Driving section

131 Heating electric wire

131a Electric wire end

D11 Forward-backward direction

D12 Shaft length direction

What is claimed is:

1. A charging inlet comprising:
a charging inlet main body configured to be installed in a vehicle and including a tubular hood,
wherein the hood is configured for fitting a connected end of a charging connector therein to connect the connected end to the charging inlet main body so that power is supplied to the charging inlet main body from the charging connector;
a lock mechanism including a pin element,
wherein the pin element is configured to extend through a tubular wall of the hood to enter an inside of the hood,
wherein when the charging connector is connected to the charging inlet main body, the lock mechanism is configured to introduce a tip end of the pin element into the inside of the hood to cause the tip end to enter a lock recess in an outer surface of the connected end so that removal of the charging connector is limited during a charging process; and
a pin heating section configured to heat the pin element.

2. The charging inlet according to claim 1,
wherein the lock mechanism includes:
the pin element; and
a driving section configured to hold the pin element so as to be movable forward and backward in a forward-backward direction, the forward-backward direction intersecting the tubular wall,
wherein when the charging connector is connected to the charging inlet main body, the driving section is configured to cause the tip end of the pin element to enter the inside of the hood, and
wherein the pin element includes a held portion facing away from the tip end,
wherein the held portion is provided to be held by the driving section, and
wherein the pin heating section is configured to heat the held portion.

3. The charging inlet according to claim 1,
wherein the pin heating section includes a heating electric wire wound around the pin element, and
wherein the pin heating section is configured to cause the heating electric wire to generate heat via supplying a heating power to the heating electric wire so that the pin element is heated.

4. The charging inlet according to claim 3,
wherein the pin element includes a diameter-reduced portion in a region of the pin element facing away from the tip end,
wherein the diameter-reduced portion has a reduced thickness for a predetermined length along a shaft length direction of the pin element as compared with the remainder of the pin element, and
wherein the heating electric wire is wound around the diameter-reduced portion.

5. The charging inlet according to claim 3,
wherein the heating electric wire includes an electric wire end facing away from the pin element, and
wherein the electric wire end is drawn out of the pin heating section and connected to an onboard power supply of the vehicle so that the heating power is supplied to the heating electric wire from the onboard power supply.
